(19) United States
(12) Patent Application Publication
(10) Pub. No.: US 2012/0121899 A1
(43) Pub. Date: May 17, 2012

(54) GLOSSING ADDITIVE FOR PAPER COATINGS

(75) Inventor: Richard E. Kajander, Plover, WI (US)

(73) Assignee: NEWPAGE CORPORATION, Miamisburg, OH (US)

(21) Appl. No.: 12/947,559

(22) Filed: Nov. 16, 2010

(51) Int. Cl. B32B 27/10; B32B 29/00; B32B 5/00

(52) U.S. Cl. 428/342; 428/511; 428/479.6

(57) ABSTRACT

A coated paper and a coating composition for forming a coated paper. In accordance with one aspect, a coated paper is disclosed comprising a coating on a paper substrate wherein the coating contains a pigment and a binder as well as a high molecular weight polyethylene glycol (PEG).

### BACKGROUND

The present application relates to paper coatings containing a glossing additive and to coated papers produced therefrom. More specifically, in accordance with certain aspects, the paper coating disclosed herein contains a glossing additive that can provide improved wet strength in the coated paper.

In accordance with certain aspects of the present invention, a pigmented paper coating is described which provides a glossy coating surface and improved wet resistance when applied to a paper substrate.

Papers or other substrates may be coated with coatings containing a variety of materials to enhance gloss of the finished coated paper. Hollow sphere plastic pigments are frequently included in coating compositions to impart gloss to the coated paper. These pigments are typically styrenic latex emulsions containing hollow spheres from about 0.5 to 2.0 microns. Commercially available hollow sphere plastic pigments include those sold by Rohm & Haas/Dow under the ROPAQUE® name. Hollow sphere plastic pigment latex generates gloss with round empty volumes exposing shiny, high Tg polymeric styrene surfaces to the action of heated rolls in a supercalender. When calendered, the dry hollow spheres flatten and remain shiny to provide a glossy surface. Solid bead spheres have also been used to generate gloss but the solid beads are more difficult to calender and are less efficient in obtaining gloss on a dry weight basis than hollow spheres.

### SUMMARY

The present application describes a coated paper and a coating composition for forming a coated paper. In accordance with one aspect of the present invention, a coated paper is disclosed comprising a coating on a paper substrate. In accordance with one aspect, the coating contains a pigment and a binder as well as a high molecular weight polyethylene glycol (PEG). The resulting coated paper typically exhibits acceptable gloss and wet resistance. In accordance with certain aspects of the present invention, the average molecular weight (Mw) of the polyethylene glycol is at least 6000, more particularly at least 8000 and in certain cases at least 10000.

In accordance with certain embodiments, the paper coating may include a combination of pigments. In accordance with other embodiments, the coating may contain a combination of binders.

Another embodiment of this invention relates to a coated sheet that includes a paper substrate to which the above-described coating has been applied. The coated sheet may be particularly suitable for various printing processes.

In accordance with one aspect of the present invention, a method of producing a coated paper is provided. The method may include the steps of forming a base stock, coating at least one side of the base stock to form a coated base stock, and finishing the coated base stock to provide a finished coated paper.

In accordance with another aspect of the present invention, a method of coating a web of cellulose fibers is provided. The method in accordance with this aspect of the invention includes coating at least one side of the web with a coating composition to form a coated paper web, and calendering the coated paper web to produce a glossy surfaced paper. In accordance with certain aspects of the present invention, the method described herein results in a product having a TAPPI Method 480 (OM-90, Specular Gloss of Paper and Paperboard at 75 Degrees, 1990), of at least about 65.

### DETAILED DESCRIPTION

The method of the present invention provides a paper product coated on at least on side with a pigmented coating containing a high molecular weight polyethylene glycol. As used herein, “paper product” includes all varieties of paper or paperboard materials. The term “gloss” refers to gloss as measured in accordance with TAPPI method 480 as determined at a 75° angle of reflectance in accordance with TAPPI Test Method T 480 om-90, Specular Gloss of Paper and Paperboard at 75 Degrees, 1990, the contents of which are hereby incorporated by reference. Glossy grades of coated papers typically have a gloss of from about 60 to about 90.

Papers produced in accordance with certain aspects of the present invention typically have gloss values of at least about 60, more particularly of at least about 65, and in accordance with certain aspects of the invention at least about 70 and in some cases at least about 80.

Unless otherwise noted, amounts of component materials are expressed in terms of component parts per 100 parts of total pigment on a weight basis.

In accordance with one aspect of the present invention, a base stock is formed and then coated. The “base stock” may be a dried web or sheet or material otherwise formed from a paper furnish comprised of wood pulp and, optionally, other additives. In accordance with a particular aspect of the invention, the pulp is comprised mainly of chemical pulp, but the furnish may contain, if desirable, other types of pulp including mechanical pulp, semi-chemical pulp, recycled pulp, pulp containing other natural fibers, synthetic fibers, and any combination thereof. The base stock may be of any suitable fiber combination having a uniform dispersion of cellulosic fibers alone or in combination with other fiber materials, such as natural or synthetic fiber materials. Examples of suitable substrates include previously coated or uncoated paper or paperboard stock of a weight ranging from about 30 lbs/ream to about 250 lbs/ream, more particularly from about 35 lbs/ream to about 190 lbs/ream for a ream size of 3300 ft².

The base stock may be pre-coated or sized prior to being coated with the coating described herein. In accordance with some embodiments of the present invention, a pre-coating or size coating of about 2-8 lbs/ream, more particularly from about 2-4 lbs/ream may be applied to one or both sides of the web. This pre-coating process may reduce the absorption characteristics of the paper web as well as make the web more uniform and increase the surface smoothness of the web. Coating compositions that can be applied in this optional step are not particularly limited. By way of example, the coating may contain mineral pigments, a synthetic binder and a synthetic thickener. Furthermore, it may be desirable to include a non-stick agent as an additive in the coating composition to suppress sticking to the calender roll during any subsequent calendering operations. Moreover, if any of the calender rolls in the subsequent calendering operations are heated, the coating composition in general and the synthetic binder in particular should be chosen to be compatible with the operating temperature of the heated roll. The pre-coat composition can be applied in accordance with conventional coating techniques. Examples of particularly useful coating methods include film coating, blade coating and other such coating devices. In accordance with particular aspects of the present invention, starch surface sizing may be applied to the web prior to calendering.

In accordance with one aspect, the coating for producing the glossy coated paper product contains a pigment and a binder as well as a high molecular weight polyethylene glycol (PEG) as a glossing additive. In accordance with particularly useful embodiments of the present invention, the resulting coated paper exhibits desirable levels of gloss and wet resistance. In accordance with certain aspects of the present invention, the average molecular weight (Mw) of the polyethylene glycol is at least 6000, more particularly at least 8000 and is certain cases at least 10000. The upper limit for the average molecular weight is not particularly restricted with polyethylene glycols having molecular weights of up to 30,000, more particularly up to 25,000 expected to be useful herein. Polyethylene glycols having an average molecular weight of at least 10000 are particularly useful for maintaining wet resistance of the coated paper product.

The polyethylene glycol is present in the coating composition in an amount sufficient to provide the desired properties in the paper product. Typically, the polyethylene glycol is present in an amount of about 0.5 to about 4 parts per 100 parts of pigment on a dry weight basis, more particularly from about 1 to 2 parts per 100 parts dry pigment.

Polyethylene glycols suitable for use in the present application can be obtained from various commercial sources. Specific examples of polyethylene glycols that can be used include Dow Chemical Company's Carbowax, Clariant Corporation's Cartacoat, Sanyo Chemical Industries' PEG, BASF's Pluriol, Lamberti S.p.A's Lamlux, Taizhou Triunion Co., Ltd's polyethyleneglycol, and Jiangsu Haian Petrochemical's Haishihua polyethylene glycol.

High molecular weight polyethylene glycol is easy to disperse in water based coating systems and provides gloss when dried. The inclusion of polyethylene glycol at various molecular weights in a paper coating typically has little effect on coating rheology and does not interfere with printing inks. In accordance with certain aspects, the inclusion of polyethylene glycol will also provide a boost to optical brighteners. The presence of polyethylene glycol in the coating composition can also assist in surface lubrication when the coated paper is passed through a supercalender.

High molecular weight polyethylene glycols can be substituted for one or more components typically used in paper coating compositions and provide coated papers exhibiting comparable properties. Components that can be partially or wholly replaced by high molecular weight polyethylene glycols include hollow sphere plastic pigments, lubricants and polyvinyl alcohol. In some embodiments, the coating is free of plastic pigments. Still other embodiments are free of polyvinyl alcohol. In yet other embodiments, the coating may be free of other lubricants besides the glossing additive. In particularly useful embodiments, the coating may be free of other lubricants besides the glossing additive and may be free of plastic pigment and/or polyvinyl alcohol. In still other embodiments, the coating may contain only a minimal amount of plastic pigment and/or polyvinyl alcohol. A minimal amount of plastic pigment may be no more than 0.5 parts per 100 parts pigment and a minimal amount of polyvinyl alcohol may be no more than 0.3 parts per 100 parts pigment. A coating composition is considered to be substantially free of plastic pigment and/or polyvinyl alcohol if it contains less than 0.1 parts per 100 parts pigment of the component.

The coating for producing the glossy coated sheet typically includes one or more pigments. In certain cases, the pigments may include a primary pigment in combination with one or more other pigments. The primary pigment may make up 45 to 100 parts of the coating pigment on a dry weight basis. In certain embodiments, the primary pigment is from about 55 to 85 parts of the pigment weight. Further, the coating typically includes at least one binder. Pigments typically comprise the largest portion of the coating composition on a dry weight basis.

Calcium carbonate is a particularly useful pigment and it can be used in any form, including aragonite, calcite or mixtures thereof. Aragonite is a particularly useful calcium carbonate. An advantage to using aragonite as the primary pigment is that the porous structure of the coating better withstands calendering to give it a gloss finish. When other forms of calcium carbonate are used in coatings, surface pores can be compacted so that some absorbency can be lost before a significant amount of gloss is achieved. A particularly useful aragonite is Specialty Minerals OPACARB A40 pigment (Specialty Minerals, Inc., Bethlehem, Pa.). A40 has a particle size distribution where 99% of the particles have a diameter of from about 0.1 to about 1.1 microns. In accordance with particular embodiments, calcium carbonate is present in an amount from about 45 to about 75 parts pigment. In accordance with other aspects, the coating may contain from about 0 to about 20 parts calcium carbonate per 100 total parts pigment.

Another calcium carbonate having a narrow particle size distribution useful herein is OMYA CoverCarb85 ground calcite calcium carbonate (OMYA AG, Oftringen, Switzerland). It provides the porous structure for successful ink absorption but less paper gloss development. This calcium carbonate, in accordance with certain embodiments, has a particle size distribution where 99% of the particles have a diameter less than 2 microns.

The coating composition may also contain secondary and/or supplemental pigments, which may be present in amounts greater than 5 parts pigment per 100 total parts pigment. These pigments may be present in amounts from about 7-50 parts, more particularly from about 20-40 parts. Examples of secondary pigments include clays, carbonates, silicates, silicas, titanium dioxide, aluminum oxides and aluminum trihydrates. Rutile TiO₂, such as DuPont's R PS-Vantage, is a particularly useful secondary pigment. Clays can also be utilized in the coating formulation. Examples of commercially available clays that can be included in the coating formulation described herein include Hydragloss 90 (Kamin) and Kaofine 90 (Thiele Kaolin).

Supplemental pigments are optional and may include pigments used in the formulation as needed to improve gloss, whiteness or other coating properties. Examples of supplemental pigments include a coarse ground calcium carbonate, other carbonates, plastic pigment, TiO₂, and mixtures thereof. An example of a ground calcium carbonate is Carbital 35 calcium carbonate (Imerys, Roswell, Ga.). Another supplemental pigment is titanium dioxide, such as that available from Itochu Chemicals America (White Plains, N.Y.). Hollow spheres are particularly useful plastic pigments for paper glossing. Examples of hollow sphere pigments include ROPAQUE AF-1533, ROPAQUE 1353 and ROPAQUE AF-1055 (Rohm & Haas, Philadelphia, Pa.). Higher gloss papers are obtainable when fine pigments are used that have a small particle size. The relative amounts of the supplemental pigments are varied depending on the whiteness and desired gloss levels.

Any pigments typically used in paper coatings can be considered to be primary, secondary of supplemental pigments depending on the relative amounts that the pigments are present in the coating. In some cases, there may not be a primary pigment but a combination of secondary and/or supplemental pigments.

A binder is added to the coating for adhesion. The binder in certain embodiments is a styrene/butadiene latex (“SBR Latex”). In accordance with certain aspects, the SBR Latex is a carboxylated styrene butadiene copolymer latex admixture and may contain acrylonitrile. Highly hydrophilic polymers may be used. Commercially available SBA latex binders include Styronal 4606 (BASF), GenCryl 9750 (Omnova), and GenCryl 8180 (Omnova). The total amount of binder typically is from about 2 to about 13 parts per 100 parts of total pigments.

The coating may also include a co-binder that is used in addition to the primary binder. Examples of useful co-binders include polyvinyl alcohol and protein binders. The co-binder typically is used in amounts of about 0.5 to about 4 parts co-binder per 100 parts of pigment on a dry weight basis, more particularly from about 1.5 to 3 parts co-binder per 100 parts dry pigment. The binder levels should be carefully controlled. If too little binder is used, the coating structure lacks physical integrity, while if too much binder is used, the coating becomes less porous resulting in longer ink drying times and also decreases gloss.

Another co-binder that is useful in some embodiments is starch. Both ethylated and enzyme-converted anionic starches may be used as a co-binder. ADM Clineo 716 starch is an ethylated cornstarch (Archer Daniels Midland, Clinton, Iowa) that can be used. Other useful starches include C*Film 7311 and Filmflex 70 (both available from Cargill) and Pengum 290 (Penford). In accordance with certain embodiments, the total amount of starch is less than 8 parts, more particularly less than 5 parts and in some cases less than 2 parts per 100 parts total pigment.

In accordance with certain embodiments, a conventional lubricant is optionally added to reduce drag when the coating is applied with a blade coater. Examples of commercially available lubricants that can be used include Nopecote C104 (Omnova), Berchem 4552 (Bercen), and Calsan 55 (BASF).

Other optional additives may be used to vary properties of the coating. Brightening agents, such as Clariant Leucophor T26 or T100 Optical Brightening Agent, (Clariant Corporation, McHenry, Ill.) can be used. Insolubilizers or cross-linkers may be useful. A particularly useful cross-linker is Sequarez 755 (Omnova, Akron, Ohio).

Conventional mixing techniques may be used in making this coating. If starch is used, it is typically cooked prior to preparing the coating using a starch cooker. In accordance with certain embodiments, the starch may be made down to approximately 35% solids but often much less. Separately, all of the pigments may be mixed for several minutes to ensure no settling has occurred. In the laboratory, the pigments may be mixed on a drill press mixer using a paddle mixer. Typically, the primary binder may then added to the mixer, followed by the co-binder, if one is used. If starch is used, it is typically added to the mixer while it is still warm from the cooker, approximately 190° F. The final coating is made by dispersion of the mixed components in water. Solids content of the dispersion typically is from about 55% to about 68% by weight. More particularly, the solids may be about 58% to about 62% of the dispersion by weight.

Yet another embodiment relates to an improved printing paper having a paper substrate to which the coating has been applied on at least one surface. Any coating method or apparatus may be used, including, but not limited to, roll coaters, jet coaters, blade coaters or rod coaters. The coating weight is typically about 3 to about 12 pounds, more particularly about 6 to about 10 pounds, per 3300 ft.² per side, to size press, pre-coated or unsized base papers. Coated papers would typically range from about 30 lb. to about 250 lb./3300 ft.² of paper surface.

The coated paper is then optionally finished as desired to the desired gloss. The coated paper may be finished in accordance with conventional finishing processes to provide the desired finished properties for the coated paper. In accordance with certain aspects, the sheet may be calendered at temperatures ranging from about ambient to about 240° F. using a traditional supercalender stack under commercially used conditions typically used with plastic pigment containing coatings to obtain the desired gloss levels.

The finished coated paper is typically produced to be relatively smooth. In accordance with certain embodiments, the coated paper may have a Parker Print Surface less than 2.0 microns, more particularly less than 1.7 microns and in some cases less than 1.5 microns. Parker Print Surface measures the roughness of the paper surface under conditions intended to simulate the nip pressures and backing substrates in printing processes. The lower the Parker print Surface value, the smoother the paper surface. The TAPPI standard test method for Parker Print Surface is T 555 om-99.

The substrate or base sheet may be a conventional base sheet. Examples of useful base sheets include NewPage 60 lb. Web Offset base paper, Orion, and NewPage 105 lb. Satin Return Card Base Stock, both from NewPage Corporation (Wisconsin Rapids, Wis.).

The finished coated paper is useful for printing Ink is applied to the coating to create an image. After application, the ink vehicle penetrates the coating and is absorbed therein. The number and uniformity of the coating pores result in even and rapid ink absorption, even when multiple layers of ink are applied. This coated paper may also be well suited for multifunctional printing, whereby an image on a coated paper media is created from combinations of dyes or pigmented inks from ink jet printers, toner from laser printers and inks from offset or gravure or flexo presses.

The following non-limiting examples illustrate specific aspects of the present invention.

The following base formulation was modified as indicated below to provide the test coatings. The coatings were applied to an 80 lb. Fortune Gloss base sheet with a coat weight target per side=8.0 lb.+/−0.5 lb.

Coating formula (pilot runs sequence 10045 to 10067)

| Coating ingredient | Dry parts |
|---|---|
| GCC (Carbital 90) | 47.5 |
| clay | 43.5 |
| coarse GCC (C-30) | 5 |
| plastic pigment | varied 0-to-4 |
| SBA latex | 9.5 |
| starch | 1.5 |
| Various PEGs | varied 0-to-6 |
| PVOH (Celvol 103) | 0-to-0.5 |
| glyoxal insolubilizer (Sequarez 755) | 0.15 |
| viscosity modifier (Rhoplex RM-232) | 0.2 |
| Lubricant | varied 0-to-1 |
| Leucophor HST (tetra OBA variant) | 2.35 (as-is) |
| polyacrylate dispersant (Dispex N40V) | 0.14 |

TABLE 1
Pilot Run Coatings

| Run sequence | conditions |
|---|---|
| 10045 | 4 p PP, 0 p PVOH, 0 p lubricant “control w/o PVOH” |
| 10047 | 4 p PP, ½ p PVOH, 1 p lubricant “full control” |
| 10049 | 0 p PP, 0 p PVOH, 0 p lubricant “low control dull” |
| 10051 | 2 p PP, 0 p PVOH, 0 p lubricant “partial control” |
| 10053 | 2 p PEG8000 w/o PP, PVOH or lubricant |
| 10055 | 4 p PEG8000 w/o PP, PVOH or lubricant |
| 10057 | 2 p PEG4000 w/o PP, PVOH or lubricant |
| 10059 | 4 p PEG4000 w/o PP, PVOH or lubricant |
| 10063 | 2 p PEG10000 w/o PP, PVOH or lubricant |
| 10065 | 4 p PEG10000 w/o PP, PVOH or lubricant |
| 10067 | 6 p PEG10000 w/o PP, PVOH or lubricant |

Pilot coating run sequence 10047 was run first as the normal control to a 75° gloss target of 72. Conditions were 1500 fpm feltside at 900 pli ambient temp followed by 1700 fpm wireside at 900 pli ambient. All other coating sequences were run on the pilot SC at these same conditions.

TABLE 2
Test results on pilot calendered paper

| | | Adams | Prufbau Pre- | Prufbau | IGT7 4 5 | IGT7 4 5 | | |
|---|---|---|---|---|---|---|---|---|
| | | Wet | wet Trap | Pre-wet | m/s Sample | m/s Sample | | |
| Sample | Side | Rub | Density | Trap Rating | 1 CF | 1 Delam | GLOSS | OPACITY |
| 10045 | W | 2.7 | 1.23 | VSCP | 137 | 203 | 78.9 | 93.7 |
| | F | 2.2 | 1.34 | VSCP | 121 | 192 | 75.5 | |
| 10047 | W | 2.2 | 1.31 | VSCP | 137 | 196 | 78.1 | 93.9 |
| | F | 1.9 | 1.40 | NP | 119 | 205 | 73.8 | |
| 10049 | W | 2.0 | 1.27 | SCP | 121 | 186 | 72.0 | 93.7 |
| | F | 2.0 | 1.42 | NP | 123 | 180 | 68.8 | |
| 10051 | W | 1.2 | 1.23 | VSCP | 102 | 111 | 74.6 | 93.6 |
| | F | 1.9 | 1.35 | VSCP | 119 | 168 | 70.4 | |
| 10053 | W | 2.2 | 0.81 | HCP | 129 | 180 | 72.8 | 93.3 |
| | F | 2.5 | 1.02 | CP | 119 | 151 | 69.1 | |
| 10055 | W | 2.0 | 1.29 | VSCP | 123 | 178 | 72.0 | 93.4 |
| | F | 2.5 | 1.20 | SCP | 106 | 129 | 68.5 | |
| 10057 | W | 2.2 | 0.75 | HCP | 141 | 196 | 71.9 | 93.4 |
| | F | 2.2 | 1.01 | CP | 121 | 178 | 69.1 | |
| 10059 | W | 3.3 | 0.88 | CP | 129 | 184 | 70.5 | 93.2 |
| | F | 2.7 | 0.78 | CP | 123 | 190 | 69.4 | |
| 10063 | W | 2.7 | 1.01 | CP | 123 | 192 | 71.42 | 93.1 |
| | F | 2.5 | 1.05 | SCP | 121 | 180 | 69.97 | |
| 10065 | W | 3.2 | 1.12 | SCP | 137 | 170 | 73.71 | 93.3 |
| | F | 2.5 | 1.18 | NP | 117 | 174 | 70.61 | |
| 10067 | W | 2.5 | 1.31 | VSCP | 117 | 147 | 72.36 | 93.0 |
| | F | 2.8 | 1.26 | VSCP | 82 | 133 | 69.56 | |

NP—No pick
VSCP—Very slight coating pick
SCP—Slight coating pick
CP—Coating pick
HCP—Heavy coating pick

The 10000PEG shows slight (SCP) wet picking and comes close to control values at 2 p. As PEG use increases, wet picking and Prewet Trap values tend to improve but at the cost of increased Deltack slope. All conditions reported the same Pre-wet Pick of “5” and the same wet Tri-pick of “3”. Deltack curves are summarized below. Deltack slopes are up and initial pick passes are generally down for all PEGs in this example versus the PP standard control. Higher PEG levels show even larger Deltack slope increases. Coated paper in accordance with certain aspects of the present invention has a Prufbau prewet trap density of at least 1.0, at least 1.1 and in certain cases at least 1.2.

TABLE 3
Test results Deltack summary

| | | Initial | | Initial | |
|---|---|---|---|---|---|
| | | Pick | Slope | Pick | |
| Sample | Side | Pass | (×1000) | Force | COATING |
| 10045 | W | 7 | 17.7 | 2.48 | 4 p PP 0 p PVOH |
| | F | 8 | 23.2 | 3.02 | 0 p lubricant |
| | | | | | (Control w/o PVOH) |
| 10047 | W | 7 | 16.7 | 2.43 | 4 p PP ½ p PVOH |
| | F | 8 | 25.0 | 3.15 | 1 p lubricant |
| | | | | | (“full” control) |
| 10049 | W | 7 | 16.7 | 2.43 | 0 p PP 0 p PVOH |
| | F | 8 | 22.6 | 3.02 | 0 p lubricant |
| | | | | | (‘low” control |
| | | | | | dull w/o PP) |
| 10051 | W | 8 | 16.3 | 2.60 | 2 p PP 0 p PVOH |
| | F | 6 | 36.5 | 3.33 | 0 p lubricant |
| | | | | | (“partial” control) |
| 10053 | W | 6 | 31.4 | 3.16 | 2 p 8000PEG |
| | F | 8 | 22.2 | 2.91 | |
| 10055 | W | 4 | 51.2 | 3.08 | 4 p 8000PEG |
| | F | 5 | 43.5 | 3.34 | |
| 10057 | W | 5 | 29.5 | 2.73 | 2 p 4000PEG |
| | F | 6 | 32.0 | 3.18 | (Cartacoat GP) |
| 10059 | W | 4 | 45.8 | 3.02 | 4 p 4000PEG |
| | F | 4 | 49.5 | 3.28 | (Cartacoat GP) |
| 10063 | W | 4 | 34.6 | 2.69 | 2 p 10000PEG |
| | F | 6 | 36.6 | 3.63 | |
| 10065 | W | 4 | 38.0 | 2.79 | 4 p 10000PEG |
| | F | 5 | 40.9 | 3.40 | |
| 10067 | W | 4 | 32.6 | 2.70 | 6 p 10000PEG |
| | F | 4 | 27.7 | 2.50 | |

All pilot calendered data above ran to the stack conditions first established and run on set 10047. This led to further calender work to determine the level of difficulty in maintaining gloss and can be found in Tables 5 and 6. The Single Color Halftone & Solid Heidelberg testing was conducted on the calendered sets above, with a summary in Table 4. Total pick counts were significantly lower with 2 p of higher mole weight PEGs. PP does not contribute to binding strength, being inert hollow styrene beads. Ink gloss was not affected as much as calendered gloss reported above.

TABLE 4
Print Lab Summary

| | | | Halftone - | | |
|---|---|---|---|---|---|
| | | | IA 50% | Total | |
| | Wire/ | Ink | Rating | Heidelberg | |
| Sample | Felt | gloss | (Average) | Picks | COATING |
| 10045 | W | 88 | 5.72 | 6 | 4 p PP 0 p PVOH |
| | F | 86 | 5.16 | 26 | 0 p lubricant |
| | | | | | (Control w/o PVOH) |
| 10047 | W | 84 | 6.75 | 3 | 4 p PP ½ p PVOH |
| | F | 80 | 4.43 | 25 | 1 p lubricant |
| | | | | | (“full” control) |
| 10049 | W | 84 | 7.35 | 4 | 0 p PP 0 p PVOH |
| | F | 80 | 5.86 | 24 | 0 p lubricant |
| | | | | | (‘low” control |
| | | | | | dull w/o PP) |
| 10051 | W | 84 | 6.83 | 5 | 2 p PP 0 p PVOH |
| | F | 81 | 5.51 | 15 | 0 p lubricant |
| | | | | | (“partial” control) |
| 10053 | W | 84 | 5.57 | 3 | 2 p 8000PEG |
| | F | 79 | 4.62 | 5 | |
| 10055 | W | 83 | 5.98 | 2 | 4 p 8000PEG |
| | F | 77 | 4.59 | 48 | |
| 10057 | W | 84 | 5.94 | 6 | 2 p 4000PEG |
| | F | 81 | 4.73 | 32 | (Cartacoat GP) |
| 10059 | W | 83 | 5.51 | 7 | 4 p 4000PEG |
| | F | 78 | 2.85 | 31 | (Cartacoat GP) |
| 10063 | W | 83 | 6.06 | 2 | 2 p 10000PEG |
| | F | 79 | 4.03 | 8 | |
| 10065 | W | 84 | 5.04 | 2 | 4 p 10000PEG |
| | F | 80 | 3.32 | 33 | |
| 10067 | W | 81 | 4.75 | 2 | 6 p 10000PEG |
| | F | 77 | 2.70 | 20 | |

Data suggests gloss can be maintained with line speed decrease or higher pli at modest caliper decrease. In accordance with certain embodiments, gloss was maintained when 1 p PEG displaced 3 p PP. Parker Print Smoothness values reflect the soft, non-spherical and non-particulate nature of PEG versus PP. Table 5 reflects 4 p PEG use.

TABLE 5
Gloss Development with Hand Calendering
4 p PEG containing sets

| | | Wire/ | | PPS -5 | caliper |
|---|---|---|---|---|---|
| Sample | Conditions | Felt | Gloss | (μ) | (mils) |
| 10047 | Ambient, 25 fpm, | W | 73.8 | 1.61 | 3.82 |
| 4 p PP | 1000 pli, 2 nips/side | F | 69.0 | 1.64 | |
| control | | | | | |
| 10055 | 120° F., 25 fpm, | W | 72.9 | 1.48 | 3.60 |
| 4 p PEG 8000 | 1200 pli, 2 nips/side | F | 66.1 | 1.51 | |
| | 150° F., 25 fpm, | W | 77.9 | 1.34 | 3.59 |
| | 1200 pli, 2 nips/side | F | 72.4 | 1.38 | |
| 10059 | 120° F., 25 fpm, | W | 71.8 | 1.37 | 3.66 |
| 4 p PEG 4000 | 1000 pli, 2 nips/side | F | 66.5 | 1.38 | |
| (comparative) | Ambient, 25 fpm, | W | 75.0 | 1.35 | 3.72 |
| | 1200 pli, 4 nips/side | F | 71.0 | 1.37 | |
| | 150° F., 25 fpm, | W | 76.6 | 1.21 | 3.55 |
| | 1000 pli, 2 nips/side | F | 71.4 | 1.29 | |
| 10065 | 120° F., 25 fpm, | W | 73.9 | 1.29 | 3.63 |
| 4 p PEG 10000 | 1100 pli, 2 nips/side | F | 68.3 | 1.38 | |
| | 150° F., 25 fpm, | W | 80.0 | 1.13 | 3.46 |
| | 1100 pli, 2 nips/side | F | 74.9 | 1.25 | |
| | Ambient, 25 fpm, | W | 74.0 | 1.35 | 3.66 |
| | 1200 pli, 4 nips/side | F | 69.0 | 1.41 | |

Based on the high Deltack slopes at 4 p PEG use, 2 p PEG samples were calendered as described in Table 6. Running 2 nips/side undershot the gloss target of 4 p PP while 4 nips/side overshot it. 3 nips/side on an 11″ hand calender appears to be a rough approximation of production supercalendering.

TABLE 6
Gloss Development with Hand Calendering
2 p PEG containing sets

| | | Wire/ | | PPS -5 | caliper |
|---|---|---|---|---|---|
| Sample | Conditions | Felt | Gloss | (μ) | (mils) |
| 10047 | Ambient, 25 fpm, | W | 73.8 | 1.61 | 3.82 |
| 4 p PP | 1000 pli, 2 nips/side | F | 69.0 | 1.64 | |
| control | | | | | |
| 10053 | Ambient, 25 fpm, | W | 73.0 | 1.44 | 3.69 |
| 2 p PEG 8000 | 1200 pli, 2 nips/side | F | 68.0 | 1.44 | |
| | Ambient, 25 fpm, | W | 77.0 | 1.34 | 3.58 |
| | 1200 pli, 4 nips/side | F | 73.0 | 1.26 | |
| 10057 | Ambient, 25 fpm, | W | 69 | 1.55 | 3.62 |
| 2 p PEG 4000 | 1200 pli, 2 nips/side | F | 67 | 1.50 | |
| (comparative) | Ambient, 25 fpm, | W | 77 | 1.32 | 3.58 |
| | 1200 pli, 4 nips/side | F | 74 | 1.33 | |
| 10063 | Ambient, 25 fpm, | W | 69 | 1.51 | 3.68 |
| 2 p PEG 10000 | 1200 pli, 2 nips/side | F | 66 | 1.54 | |
| | Ambient, 25 fpm, | W | 76 | 1.31 | 3.67 |
| | 1200 pli, 4 nips/side | F | 73 | 1.32 | |

While this invention has been described in detail with reference to certain embodiments, it should be appreciated that the present invention is not limited to those precise embodiments. Rather, in view of the present disclosure, many modifications and variations would present themselves to those skilled in the art without departing from the scope and spirit of this invention.

What is claimed is:

1. A coated paper comprising:
a paper substrate; and
a coating on at least one side of said substrate wherein the coating comprises pigment, binder and polyethylene glycol wherein the polyethylene glycol has an average molecular weight (Mw) of at least 6000, wherein at least one side of the coated paper has a gloss value (75° gloss) of at least 60.

2. The coated paper of claim 1 wherein the polyethylene glycol has an average molecular weight (Mw) of at least 8000.

3. The coated paper of claim 2 wherein the has an average molecular weight (Mw) of at least 10000.

4. The coated paper of claim 1 wherein the pigment comprises at least one pigment selected from the group consisting of calcium carbonate, clay and plastic pigments.

5. The coated paper of claim 1 wherein said polyethylene glycol is present in an amount of about 0.5 to about 4 parts per 100 parts of pigment on a dry weight basis.

6. The coated paper of claim 1 wherein said coating contains no more than 0.5 parts plastic pigment based on 100 parts total pigments.

7. The coated paper of claim 6 wherein said coating is free of plastic pigments.

8. The coated paper of claim 1 wherein said coating comprises a binder selected from the group consisting of styrene/butadiene latex binders, protein binders, polyvinyl alcohol, starch and mixtures thereof.

9. The coated paper of claim 1 wherein said pigment comprises calcium carbonate which is present in an amount of about 45 to 65 parts based on 100 parts total pigments.

10. The coated paper of claim 1 wherein at least one side of said coated paper has a gloss value (75° gloss) of at least about 65.

11. The coated paper of claim 1 wherein said coating is present at a coat weight of about 3 to 12 lbs./ream (3,300 ft.²) per side.

12. The coated paper of claim 1 wherein the polyethylene glycol has an average molecular weight (Mw) of at least 8000 and the polyethylene glycol is present in an amount of about 0.5 to about 4 parts per 100 parts of pigment on a dry weight basis and the coating is present on both sides of the substrate at a coat weight of about 3 to 12 lbs./ream (3,300 ft.²) per side.

13. The coated paper of claim 12 wherein the coated paper has a gloss value (75° gloss) of at least about 70 on at least one side of the coated paper.

14. The coated paper of claim 1 wherein the coated paper has a Prufbau prewet trap density of at least 1.0.

15. The coated paper of claim 1 wherein the coating contains no more than 8 parts starch per 100 parts total pigment.

16. The coated paper of claim 1 wherein said coating contains no more than 0.2 parts polyvinyl alcohol based on 100 parts total pigments.

17. The coated paper of claim 16 wherein said coating is substantially free of polyvinyl alcohol.

18. The coated paper of claim 17 wherein said coating contains no more than 0.5 parts plastic pigment based on 100 parts total pigments.

19. The coated paper of claim 18 wherein said coating is substantially free of plastic pigments.
